(19) United States
(12) Patent Application Publication
(10) Pub. No.: US 2020/0346309 A1
(43) Pub. Date: Nov. 5, 2020

(54) FLUID COOLING OF WELDING-TYPE SYSTEM ELECTRONICS

(71) Applicant: Illinois Tool Works Inc., Glenview, IL (US)

(72) Inventor: Travis Jack Orvedahl, Neenah, WI (US)

(21) Appl. No.: 16/403,210

(22) Filed: May 3, 2019

(51) Int. Cl. B23K 37/00; B23K 9/10

(52) U.S. Cl. CPC B23K 37/003; B23K 9/1006

(57) ABSTRACT

Systems are disclosed for providing liquid cooling of electronics of a welding-type system via pumping fluid from fluid sources available on the welding-type system through heatsinks thermally connected to the electronics. Fluid sources may include fuel for an engine of the welding-type system, hydraulic fluid, and/or lubrication oil for a rotary screw air compressor.

### BACKGROUND

Conventionally, the electronics of welding-type systems, including control circuitry and power conversion circuitry, are air cooled. Engine driven welding-type systems include a fluid fuel source. Some welding-type systems also include other fluid reservoirs, for example, lubrication oil for a rotary screw air compressor and/or hydraulic fluid for use in hydraulic applications.

### SUMMARY

Systems and methods of fluid cooling of welding-type system components are disclosed, substantially as illustrated by and described in connection with at least one of the figures.

### BRIEF DESCRIPTION OF THE DRAWINGS

FIG. 1 is a block diagram of a welding-type system that uses a prime mover fuel source as a source of liquid coolant for electronics of the welding-type system.

FIG. 2 is a block diagram of a welding-type system that uses a prime mover fuel source as a source of liquid coolant for electronics of the welding-type system.

FIG. 3 is a block diagram of a welding-type system that uses lubrication oil for a rotary screw air compressor as a source of liquid coolant for electronics of the welding-type system.

FIG. 4 is a block diagram of a welding-type system that uses hydraulic fluid as a source of liquid coolant for electronics of the welding-type system.

The figures are not necessarily to scale. Where appropriate, similar or identical reference numbers are used to refer to similar or identical components.

### DETAILED DESCRIPTION

Welding-type systems include various electronic components, including power-conversion circuitry and control circuitry. Electronics generate heat during use, and also have a permissible operating temperature. Overheating may cause the performance of the electronics to decrease, and may result in damage to the electronics. Therefore, it is often necessary for systems with power electronic components, including welding-type systems, to manage the heat produced by the electronics during use.

Typical welding-type systems are air cooled. For example, a fan may be used to blow air across a heatsink thermally connected to electronics in order to cool the electronics. As liquid has a higher specific heat than air, liquid transfers heat more effectively than air. Therefore, liquid cooling systems are typically more effective at cooling electronics than air cooled systems

Welding-type systems may include fluid/liquid reservoirs that contain fluid for various purposes. Example fluids that may he present in welding-type systems include fuel for an engine that drives a generator that provides power for the welding-type system, lubrication oil for a rotary-screw air compressor, and hydraulic fluid for a hydraulic pump. The present disclosure relates to using fluid from fluid reservoirs present on welding-type systems as a liquid coolant to cool electronics of the welding-type systems.

Disclosed example engine driven welding-type systems include: an engine; a fuel reservoir containing fluid fuel; a fuel pump; and a heatsink in thermal communication with electronics of the engine driven welding-type system, where the fuel pump is configured to pump fluid fuel from the fuel reservoir to the heatsink via a first conduit.

In some example engine driven welding-type systems, the heatsink includes at least one channel through which fluid fuel pumped to the heatsink via the first conduit flows.

In some example engine driven welding-type systems, the heatsink includes an aluminum alloy plate.

In some example engine driven welding-type systems, the electronics include power conversion circuitry.

In some example engine driven welding-type systems, the electronics include a control circuit of the engine driven welding-type system.

In some example engine driven welding-type systems, fluid fuel pumped to the heatsink returns from the heatsink to the fuel reservoir via a second conduit.

Some example engine driven welding-type systems further include a radiator, and fluid fuel returns from the heatsink to the fuel reservoir through the radiator.

In some example engine driven welding-type systems, fluid fuel pumped to the heatsink flows via a second conduit from the heatsink to the engine for combustion to power the engine.

Disclosed welding-type systems include: a fluid reservoir containing fluid, where the fluid is one of lubrication oil for a rotary screw air compressor, fluid fuel for a combustion engine, or hydraulic fluid for a hydraulic pump; a heatsink in thermal communication with electronics of the welding-type system; and a fluid pump configured to pump fluid from the fluid reservoir to the heatsink via a first conduit.

In some example welding-type systems, heatsink includes at least one channel through which fluid pumped to the heatsink via the first conduit flows.

In some example welding-type systems, the heatsink includes an aluminum alloy plate.

In some example welding-type systems, the fluid reservoir contains lubrication oil for the rotary screw air compressor, and the lubrication oil flows from the heatsink to the rotary screw air compressor via a second conduit.

In some example welding-type systems, the fluid reservoir contains lubrication oil for the rotary screw air compressor, and the lubrication oil pumped to the heatsink returns to the fluid reservoir via a second conduit.

In some example welding-type systems, the electronics include a control circuit of the rotary screw air compressor.

In some example welding-type systems, the fluid reservoir contains hydraulic fluid for a hydraulic pump, and the hydraulic fluid flows from the heatsink to the hydraulic pump via a second conduit.

In some example welding-type systems, the fluid reservoir contains hydraulic fluid for a hydraulic pump, and the hydraulic fluid pumped to the heatsink returns to the fluid reservoir via a second conduit.

In some example welding-type systems, the electronics comprise a control circuit of the hydraulic pump.

In some example welding-type systems, the electronics include power conversion circuitry.

Some example welding-type systems further include a radiator, and fluid returns from the heatsink to the fluid reservoir through the radiator.

Disclosed example engine driven welding-type systems include: an engine; a fuel reservoir containing fluid fuel; a heatsink in thermal communication with electronics of the engine driven welding-type system; a first pump configured to pump fuel from the fuel reservoir to the engine; and a second pump configured to pump fuel from the fuel reservoir to the heatsink.

The term “welding-type system,” as used herein, includes any device capable of supplying power suitable for welding, plasma cutting, induction heating, CAC-A and/or hot wire welding/preheating (including laser welding and laser cladding), including inverters, converters, choppers, resonant power supplies, quasi-resonant power supplies, etc., as well as control circuitry and other ancillary circuitry associated therewith.

As used herein, the term “welding-type power” refers to power suitable for welding, plasma cutting, induction heating, CAC-A and/or hot wire welding/preheating (including laser welding and laser cladding). As used herein, the term “welding-type power supply” and/or “power supply” refers to any device capable of, when power is applied thereto, supplying welding, plasma cutting, induction heating, CAC-A and/or hot wire welding/preheating (including laser welding and laser cladding) power, including but not limited to inverters, converters, resonant power supplies, quasi-resonant power supplies, and the like, as well as control circuitry and other ancillary circuitry associated therewith.

As used herein, a “circuit,” or “circuitry,” includes any analog and/or digital components, power and/or control elements, such as a microprocessor, digital signal processor (DSP), software, and the like, discrete and/or integrated components, or portions and/or combinations thereof.

The terms “control circuit” and “control circuitry,” as used herein, may include digital and/or analog circuitry, discrete and/or integrated circuitry, microprocessors, digital signal processors (DSPs), and/or other logic circuitry, and/or associated software, hardware, and/or firmware. Control circuits or control circuitry may be located on one or more circuit boards, which form part or all of a controller, and are used to control a welding process, a device such as a power source or wire feeder, and/or any other type of welding-related system.

As used, herein, the term “memory” and/or “memory device” means computer hardware or circuitry to store information for use by a processor and/or other digital device. The memory and/or memory device can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), flash memory, solid state storage, a computer-readable medium, or the like.

As used herein, the term “torch,” “welding torch,” “welding tool” or “welding-type tool” refers to a device configured to be manipulated to perform a welding-related task, and can include a hand-held welding torch, robotic welding torch, gun, or other device used to create the welding arc.

As used herein, “power conversion circuitry” and/or “power conversion circuits” refer to circuitry and/or electrical components that convert electrical power from one or more first forms (e.g., power output by a generator) to one or more second forms having any combination of voltage, current, frequency, and/or response characteristics. The power conversion circuitry may include safety circuitry, output selection circuitry, measurement and/or control circuitry, and/or any other circuits to provide appropriate features.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations.

As used herein, the term “welding mode,” “welding process,” “welding-type process” or “welding operation” refers to the type of process or output used, such as current-controlled (CC), voltage-controlled (CV), pulsed, gas metal arc welding (GMAW), flux-cored arc welding (FCAW), gas tungsten arc welding (GTAW), shielded metal arc welding (SMAW), spray, short circuit, and/or any other type of welding process.

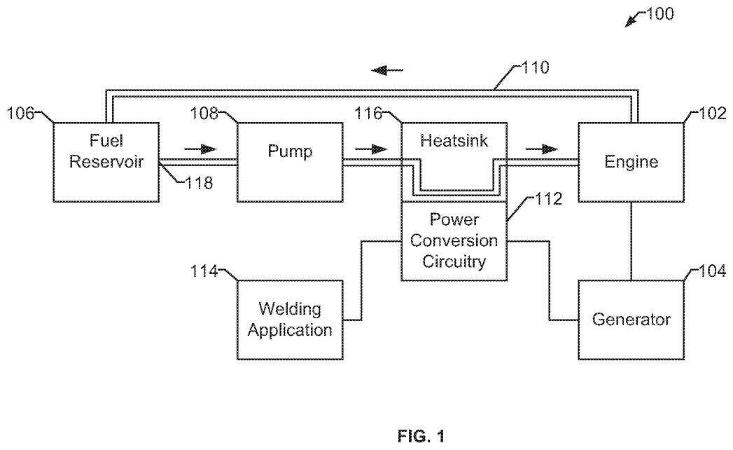

FIG. 1 is a block diagram of an engine-driven welding-type system 100 using the engine fuel source as a source of liquid coolant for electronics of the welding-type system 100. The welding-type system 100 includes an engine 102 which drives a generator 104. The engine 102 may be of any desired type, including a diesel engine or a gasoline engine. The generator is driven by the engine, i.e., the mechanical power of the engine 102 is transferred to the generator 104. The generator 104 may be directly driven by the engine 102, such as by close coupling the generator to the engine, or may be belt or chain driven, where desired. During operation, the engine consumes fuel from a fluid reservoir, such as a fuel reservoir 106, which may be one or more liquid fuel tanks. Fuel is pumped from the fuel reservoir 106 to the engine 102 via a pump 108, and excess fuel returns to the fuel reservoir 106 via a return line 110.

The generator 104 provides power to power conversion circuitry 112. The power conversion circuitry 112 provides one or more types of electrical power suitable for specific and/or general purpose uses, such as welding-type power for a welding-type application 114 and/or, 110 VAC and/or 220 VAC power for auxiliary applications. The welding-type application may be any type of welding-type application that uses any type of welding-type device, including a welder, plasma cutter, or induction heating device, which may operate in accordance with any one of many conventional welding techniques, such as stick welding, tungsten inert gas (TIG) welding, metal inert gas (MIG) welding, and so forth. Although not illustrated in FIG. 1, certain of these welding techniques may call for or conveniently use e feeders to supply a continuously fed wire electrode, as well as shielding gases and other shielding supplies. Such wire feeders may be coupled to the power conversion circuitry 112 and be powered by the power conversion circuitry 112, where desired. The power conversion circuitry 112 may also be configured to power auxiliary loads. Auxiliary loads may include lights, control circuitry, battery chargers, user interfaces, wire feeders, etc.

A heatsink 116 is thermally connected to the power conversion circuitry 112. During operation, the power conversion circuitry 112 generates heat. As the heatsink 116 is thermally connected to the power conversion circuitry 112, heat generated by the power conversion circuitry 112 is drawn into the heatsink 116. As illustrated, fuel which is pumped from the fuel reservoir 106 flows through the heatsink 116 on the way to the engine 102. The heatsink 116 may include one or more channels through which the fuel may flow. The heatsink 116 may be of any suitable material, including copper or aluminum (e.g., any suitable aluminum alloy). Fuel conduits connect the fuel reservoir 106 to the inlet(s) of the channel(s) of the heatsink 116 via the pump 108, and fuel conduits connect the outlet(s) of the channel(s) of the heatsink 116 to the engine 102. Accordingly, fuel which is used to power the engine 102 which provides power for the power conversion circuitry 112 is also used to cool the power conversion circuitry 112.

may be drawn from the fuel reservoir 106 from a location 118 in the fuel reservoir 106 which is known to be cool compared to other locations in the fuel reservoir 106. The location 118 may be a location that is located farther away from the engine 102 and/or the power conversion circuitry 112, and thus less affected by the heat from the engine 102 and/or the power conversion circuitry 112. It may be desirable to draw fuel from the cool location 118 such that cooler fuel flows through the heatsink 116. Cooler fuel allows more heat to be transferred from the heatsink 116 to the fuel, and thus allows for more effective cooling of the power conversion circuitry 112.

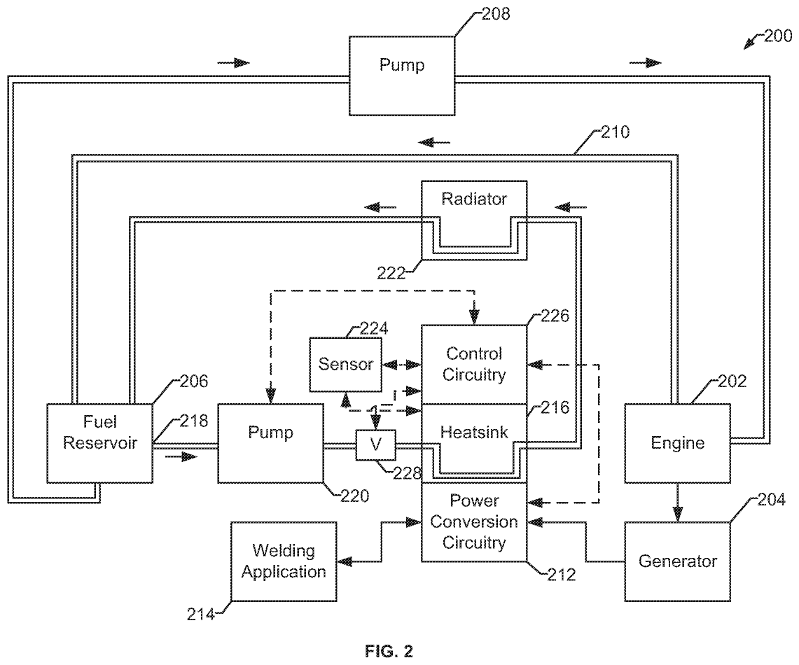

FIG. 2 is a block diagram of another engine-driven welding-type system 200 that uses the engine fuel source as a source of liquid coolant for electronics of the welding-type system. The system 200 has an engine 202, a generator 204, power conversion circuitry 112, and a welding application 214 that operate in the same manner as described with the corresponding components of system 100 of FIG. 1. Fuel to power the engine 202 is pumped from the fuel reservoir 206 to the engine 202 by a pump 208 via fuel conduits. Excess fuel returns from the engine 202 to the fuel reservoir 206 via a return line 210.

A second pump 220 pumps fuel from the fuel reservoir 206 to the heatsink 216 via conduits to cool the power conversion circuitry 212 thermally connected to the heatsink 216. The heatsink 216 may contain one or more channels through which fuel flows. The heatsink 216 may be of any suitable material, including copper or aluminum. Fuel conduits connect the fuel reservoir 206 to the inlet(s) of the channel(s) of the heatsink 216 via the pump 220, and fuel conduits connect the outlet(s) of the channel(s) of the heatsink 216 a radiator 222. An example radiator 222 may include conduits or channels and a fan which blows air across the conduits or channels. The radiator 222 dissipates heat absorbed by the fuel to the atmosphere before the fuel returns to the fuel reservoir 206.

Fuel may be drawn from the fuel reservoir 206 to cool the heatsink 216 from a location 218 in the fuel reservoir 206 which is known to be cool compared to other locations in the fuel reservoir 206. The location 218 may be a location that is located farther away from the engine 202 and/or the power conversion circuitry 212, and thus is less affected by, heat from the engine 202 and/or the power conversion circuitry 212. It may be desirable to draw fuel from the cool location 218 such that cooler fuel flows through the heatsink 216. Cooler fuel allows more heat to be transferred from the heatsink 216 to the fuel, and thus allows for more effective cooling of the power conversion circuitry 112.

The system 200 may include a temperature sensor 224 (which may include, for example, a thermocouple, an infrared thermometer, a thermistor, etc.) which senses the temperature of the heatsink 216 and/or the power conversion circuitry 212 thermally connected to the heatsink 216. The control circuitry 226 may receive temperature data from the sensor 224. The control circuitry 226 may control operation of the pump 220, the power conversion circuitry 212, the engine 202, and the generator 204.

In some examples, the control circuitry 226 may control the pump 220 to pump fuel from the fuel reservoir 206 through the heatsink 216 when the sensor 224 indicates that the heatsink 216 temperature exceeds a threshold. In some examples, the control circuitry 226 controls the rate at which the pump 220 pumps fuel through the heatsink 216 based on the temperature of the heatsink 216. As more fuel is pumped through the heatsink 216, more heat can he transferred away from the heatsink 216. Accordingly, the rate at which fuel is pumped through the heatsink 216 affects the rate at which the heatsink 216 and thus the power conversion circuitry 212 is cooled. Thus, in some examples, as the temperature of the heatsink 216 increases, the control circuitry 226 controls the pump 220 to increase the rate at which fuel is pumped through the heatsink 216, and correspondingly as the temperature of the heatsink 216 decreases, the control circuitry 226 controls the pump 220 to decrease the rate at which fuel is pumped through the heatsink 216.

In some examples, the control circuitry 226 controls the rate at which fuel flows through the heatsink 216 via adjusting the speed of the pump 220. In some examples, the control circuitry 226 controls the rate at which the fuel flows through the heatsink 216 via adjusting the position of a valve 228, The valve 228 may be included within the pump 220 or located along the fluid path between the fuel reservoir 206 and the heatsink 216.

In some examples, the control circuitry 226 is also thermally connected to the heatsink 216. Accordingly, the fuel that is pumped through the heatsink 216 also cools the control circuitry 226. In some examples, only the control circuitry 226 is thermally connected to the heatsink 216. In some examples, the control circuitry 226 is connected to one heatsink and the power conversion circuitry 212 is connected to another heatsink. In some examples, separate pumps may pump fuel from the reservoir 206 to the respective heatsinks of the power conversion circuitry 212 and the control circuitry 226. In some examples, one pump may pump fuel to the heatsinks of both the control circuitry 226 and the power conversion circuitry 212, The control circuitry 226 may control one or more valves to control whether fuel flows to the heatsinks of the control circuitry and the power conversion circuitry 212. The control circuitry 226 may also control the one or more valves to control the rate at which fuel flows to the heatsinks of the control circuitry 226 and the power conversion circuitry 212.

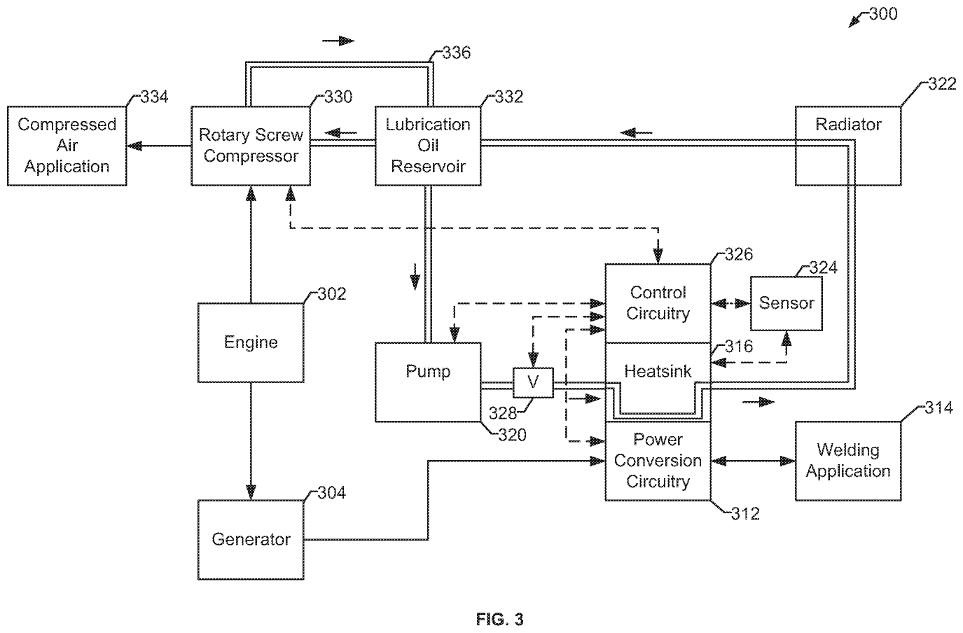

FIG. 3 is a block diagram of a welding-type system 300 that uses lubrication oil as a source of liquid coolant for electronics of the welding-type system. In some example welding-type systems, such as the system 300, the engine 302 may drive a rotary screw air compressor 330. In some examples, the engine 302 may only drive the rotary screw air compressor 330, While in some examples, as illustrated, the engine 302 may drive the rotary screw air compressor 330 in addition to a generator 304 which provides power to a welding-type application 314 via power conversion circuitry 312. The mechanical power of the engine 302 may be transferred to the generator 304 and/or the rotary screw air compressor 330 via serpentine belts and/or via a direct or indirect linkages which may include clutches or the like to selectively provide power to the generator 304 and the rotary screw air compressor 330,

The rotary screw air compressor 330 draws lubrication oil from a lubrication oil reservoir 332 during operation of the rotary screw air compressor 330. Lubrication oil returns to the lubrication oil reservoir 332 from the rotary screw air compressor 330 via a return line 336. The rotary screw air compressor 330 provides compressed air to a compressed air application 334, such as an impact wrench.

A pump 320 may pump lubrication oil from the lubrication oil reservoir 332 through the heatsink 316 via conduits. The heatsink 316 may be thermally connected to the power conversion circuitry 312, the control circuitry 326, and/or any other electronics of the system 300. Heat is transferred from the heatsink 316 to the lubrication oil that flows through the heatsink 316, and the electronics thermally connected to the heatsink 316 are thereby cooled. The lubrication oil flows through a radiator 322 to cool the lubrication oil after flowing through the heatsink 316. The radiator 322 may include conduits or channels and a fan which blows air across the conduits or channels. The radiator 322 dissipates heat absorbed by the lubrication oil to the atmosphere before the lubrication oil returns to the lubrication oil reservoir 332.

In some examples, the pump 320 may be omitted, and lubrication oil drawn by the rotary screw compressor 330 from the lubrication oil reservoir 332 flows through the heatsink 316 on the pathway from the lubrication oil reservoir 332 to the rotary screw compressor 330. In some examples where the pump 320 is omitted, the lubrication oil flows through the radiator 322 after flowing through the heatsink 316. In some examples, the pump 320 may be omitted, and the lubrication oil flows through the heatsink 316 via the return line 336 as the lubrication of to the lubrication oil reservoir 332 from the rotary screw compressor 330, In some examples, the lubrication oil also flows through the radiator 322 after flowing through the heatsink 316 as the lubrication oil returns to the lubrication oil reservoir 332 from the rotary screw compressor 330.

Control circuitry 326 may control operation of the engine 302, the generator 304, the power conversion circuitry 312, and/or the pump 320. A sensor 324 may be connected to the heatsink 316 to measure the temperature of the heatsink 316 and/or the electronics thermally connected to the heatsink. The control circuitry 326 may receive signals from the sensor 324 indicative of the temperature of the heatsink 316 and/or the electronics thermally connected to the heatsink 316.

In some examples, the control circuitry 326 may control the pump 320 to pump lubrication oil from the lubrication oil reservoir 332 through the heatsink 316 when the sensor 324 indicates that the heatsink 316 temperature exceeds a threshold. In some examples, the control circuitry 326 controls the rate at which the pump 320 pumps lubrication oil through the heatsink 316 based on the temperature of the heatsink 316, As more lubrication oil is pumped through the heatsink 316, more heat can be transferred away from the heatsink 316. Accordingly, the rate at which lubrication oil is pumped through the heatsink 316 affects the rate at which the heatsink 316, and thus the electronics thermally connected to the heatsink 316, are cooled. Thus, in some examples, as the temperature of the heatsink 316 increases, the control circuitry 326 controls the pump 320 to increase the rate at which lubrication oil is pumped through the heatsink 316, and correspondingly as the temperature of the heatsink 316 decreases, the control circuitry 326 control the pump 320 to decrease the rate at which lubrication oil is pumped through the heatsink 316,

In some examples, the control circuitry 326 controls the rate. at which lubrication oil flows through the heatsink 316 via adjusting the speed of the pump 320. In some examples, the control circuitry 326 controls the rate at which the lubrication oil flows through the heatsink 316 via adjusting the position of a valve 328. The valve 328 may be included within the pump 320 or may be located along the fluid path between the lubrication oil reservoir 332 and the heatsink 316.

In some examples, lubrication oil may be pumped through a heatsink thermally connected to certain components of the welding-type system, for example, the control circuitry, and fuel may be pumped through the heatsink thermally connected to other components of the welding-type system, for example the power conversion circuitry, as described with reference to the systems 100 and 200 of FIGS. 1 and 2.

In some examples, lubrication oil may be pumped to heatsinks thermally connected to the control circuitry 326 and the power conversion circuitry 312, either via two or more pumps or via a single pump 320. If multiple pumps are used, the control circuitry 326 may control the multiple pumps. If a single pump 320 pumps lubrication oil to multiple heatsinks, the control circuitry 326 may control valves to allow whether lubrication oil is pumped to the multiple heatsinks and the rate at which the lubrication oil is pumped to the heatsinks.

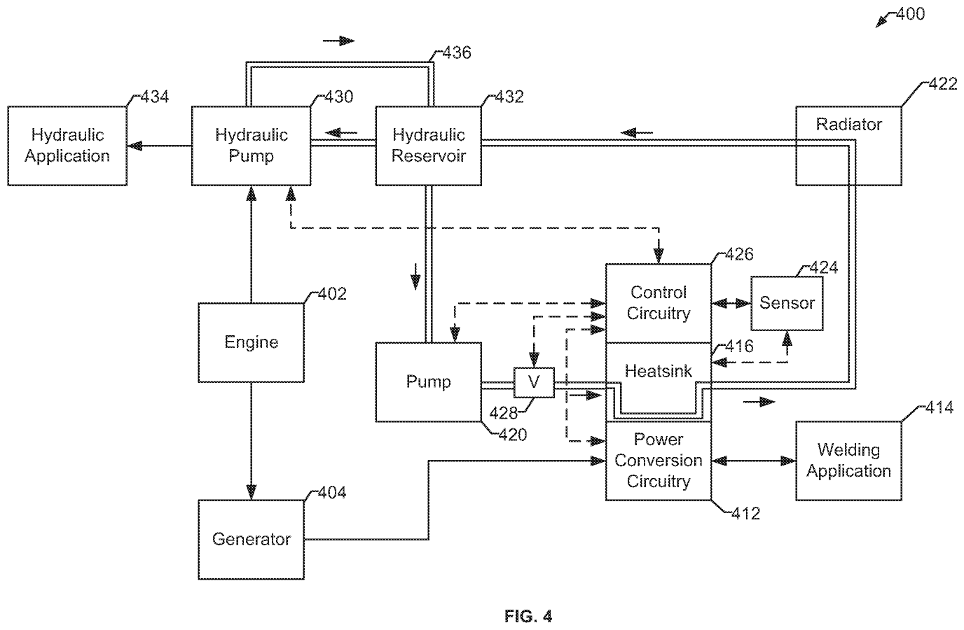

FIG. 4 is a block diagram of a welding-type system 400 that uses hydraulic fluid as a source of liquid coolant for electronics of the welding-type system. In some example welding-type systems, such as the system 400, the engine 402 may drive a hydraulic pump 430. In some examples, the engine 402 may only drive the hydraulic pump 430, while in some examples, as illustrated the engine 402 may drive the hydraulic pump 430 in addition to a generator 404 which provides power to a welding-type application 414 via power conversion circuitry 412. The mechanical power of the engine 402 may be transferred to the generator 404 and/or the hydraulic pump 430 via serpentine belts and/or via a direct or indirect linkages which may include clutches or the like to selectively provide power to the generator 404 and the hydraulic pump 430.

The hydraulic pump 430 draws hydraulic fluid from a hydraulic fluid reservoir 432 during operation of the hydraulic pump 430. Hydraulic fluid returns to the hydraulic fluid reservoir 432 from the hydraulic pump 430 via a return line 436. The hydraulic pump 430 drives a hydraulic application 434, such as a hydraulic lift (e.g., a man lift or a scissor lift).

A pump 420 may pump hydraulic fluid from the hydraulic fluid reservoir 432 through the heatsink 416 via conduits. The heatsink 416 may be thermally connected to the power conversion circuitry 412, the control circuitry 426, and/or any other electronics of the system 400. Heat is transferred from the heatsink 416 to the hydraulic fluid that flows through the heatsink 416, and the electronics thermally connected to the heatsink 416 are thereby cooled. The hydraulic fluid flows through a radiator 422 to cool the hydraulic fluid after flowing through the heatsink 416. The radiator 422 may include conduits or channels and a fan which blows air across the conduits or channels. The radiator 422 dissipates heat absorbed by the hydraulic fluid to the atmosphere before the hydraulic fluid returns to the hydraulic fluid reservoir 332.

In some examples, the pump 420 may be omitted, and hydraulic fluid drawn by the hydraulic pump 430 from the hydraulic fluid reservoir 432 flows through the heatsink 416 on the pathway from the hydraulic fluid reservoir 432 to the hydraulic pump 430. In some examples where the pump 420 is omitted, the hydraulic fluid flows through the radiator 422 after flowing through the heatsink 416. In some examples, the pump 420 may be omitted, and the hydraulic fluid flows through the heatsink 416 via the return line 436 as the hydraulic fluid returns to the hydraulic fluid reservoir 432 from the hydraulic pump 430, In some examples, the hydraulic fluid also flows through the radiator 422 after flowing through the heatsink 416 as the hydraulic fluid returns to the hydraulic fluid reservoir 432 from the hydraulic pump 430. 100641 Control circuitry 426 may control operation of the engine 402, the generator 404, the power conversion circuitry 412, and/or the pump 420. A sensor 424 may he connected to the heatsink 416 to measure the temperature of the heatsink 416. The control circuitry 426 may receive signals from the sensor 424 indicative of the temperature of the heatsink 416.

In some examples, the control circuitry 426 may control the pump 420 to pump hydraulic fluid from the hydraulic fluid reservoir 432 through the heatsink 416 when the sensor 424 indicates that the heatsink 416 temperature exceeds a threshold. In some examples, the control circuitry 426 controls the rate at which the pump 420 pumps hydraulic fluid through the heatsink 416 based on the temperature of the heatsink 416. As more hydraulic fluid is pumped through the heatsink 416, more heat can be transferred away from the heatsink 416. Accordingly, the rate at which hydraulic fluid is pumped through the heatsink 416 affects the rate at which the heatsink 416 and thus the electronics thermally connected to the heatsink 416 are cooled. Thus, in some examples, as the temperature of the heatsink 416 increases, the control circuitry 426 controls the pump 420 to increase the rate at which hydraulic fluid is pumped through the heatsink 416, and correspondingly as the temperature of the heatsink 416 decreases, the control circuitry 426 control the pump 420 to decrease the rate at which hydraulic fluid is pumped through the heatsink 416.

In some examples, the control circuitry 426 controls the rate at which hydraulic fluid flows through the heatsink. 416 via adjusting the speed of the pump 420. In some examples, the control circuitry 426 controls the rate at which the hydraulic fluid flows through the heatsink 416 via adjusting the position of a valve 428. The valve 428 may be included within the pump 420 or may be located along the fluid path between the hydraulic fluid reservoir 432 and the heatsink 416.

In some examples, hydraulic fluid may be pumped through a heatsink thermally connected to certain components of the welding-type system, for example, the control circuitry, and fuel or lubrication oil may be pumped through the heatsink thermally connected to other components of the welding-type system, for example, the power conversion circuitry, as described with reference to the systems 100, 200, and 300 of FIGS. 1, 2, and 3.

In some examples, the welding-type system is a vehicle-mounted welding-type system and includes a generator, a rotary screw air compressor, and a hydraulic pump. Any of the hydraulic fluid, lubrication oil, or fuel for the engine may be pumped through heatsinks to cool electronics of the systems thermally connected to the heatsinks, as described with reference to the systems 100, 200, 300 and 400 of FIGS. 1-4.

With reference to FIG. 4, in some examples, hydraulic fluid may be pumped to heatsinks thermally connected to the control circuitry 426 and/or the power conversion circuitry 412, either via two r more pumps or via a single pump 420. If multiple pumps are used, the control circuitry 426 may control the multiple pumps. If a single pump 420 pumps hydraulic fluid to multiple heatsinks, the control circuitry 426 may control valves to allow whether hydraulic fluid is pumped to the multiple heatsinks and the rate at which the hydraulic fluid is pumped to the heatsinks.

Although described with reference to fuel, lubrication oil for a rotary screw air compressor, or hydraulic fluid, any source of fluid available with a welding-type system could be pumped through heatsinks thermally connected to electronics of the welding-type systems in the manner disclosed to cool the electronics.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, systems, blocks, and/or other components of disclosed examples may be combined, divided, rearranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. An engine driven welding-type system comprising:
an engine;
a fuel reservoir containing fluid fuel;
a fuel pump; and
a heatsink in thermal communication with electronics of the engine driven welding-type system, wherein the fuel pump is configured to pump fluid fuel from the fuel reservoir to the heatsink via a first conduit.

2. The engine driven welding-type system of claim 1, wherein the heatsink comprises at least one channel through which fluid fuel pumped to the heatsink via the first conduit flows.

3. The engine driven welding-type system of claim 2, wherein the heatsink comprises an aluminum alloy plate.

4. The engine driven welding-type system of claim 1, wherein the electronics comprise power conversion circuitry.

5. The engine driven welding-type system of claim 1, wherein the electronics comprise a control circuit of the engine driven welding-type system.

6. The engine driven welding-type system of claim 1, wherein fluid fuel pumped to the heatsink returns from the heatsink to the fuel reservoir via a second conduit.

7. The engine driven welding-type system of claim 1, further comprising a radiator, and wherein fluid fuel returns from the heatsink to the fuel reservoir through the radiator.

8. The engine driven welding-type system of claim 1, wherein fluid fuel pumped to the heatsink flows via a second conduit from the heatsink to the engine for combustion to power the engine.

9. A welding-type system comprising:
a fluid reservoir containing fluid, wherein the fluid is one of lubrication oil for a rotary screw air compressor, fluid fuel for a combustion engine, or hydraulic fluid for a hydraulic pump;
a heatsink in thermal communication with electronics of the welding-type system; and
a fluid pump configured to pump fluid from the fluid reservoir to the heatsink via a first conduit.

10. The welding-type system of claim 9, wherein the heatsink comprises at least one channel through which fluid pumped to the heatsink via the first conduit flows.

11. The welding-type system of claim 9, wherein the heatsink comprises an aluminum alloy plate.

12. The welding-type system of claim 9, wherein the fluid reservoir contains lubrication oil for the rotary screw air compressor, and wherein the lubrication oil flows from the heatsink to the rotary screw air compressor via a second conduit.

13. The welding-type system of claim 9, wherein the fluid reservoir contains lubrication oil for the rotary screw air compressor, and wherein the lubrication oil pumped to the heatsink returns to the fluid reservoir via a second conduit.

14. The welding-type system of claim 9, wherein the electronics comprise a control circuit of the rotary screw air compressor.

15. The welding-type system of claim 9, wherein the fluid reservoir contains hydraulic fluid for a hydraulic pump, and wherein the hydraulic fluid flows from the heatsink to the hydraulic pump via a second conduit.

16. The welding-type system of claim 9, wherein the fluid reservoir contains hydraulic fluid for a hydraulic pump, and wherein the hydraulic fluid pumped to the heatsink returns to the fluid reservoir via a second conduit.

17. The welding-type system of claim 9, wherein the electronics comprise a control circuit of the hydraulic pump.

18. The welding-type system of claim 9, wherein the electronics comprise power conversion circuitry.

19. The welding-type system of claim 9, further comprising a radiator, and wherein fluid returns from the heatsink to the fluid reservoir through the radiator.

20. An engine driven welding-type system comprising:
an engine;
a fuel reservoir containing fluid fuel;
a heatsink in thermal communication with electronics of the engine driven welding-type system;
a first pump configured to pump fuel from the fuel reservoir to the engine; and
a second pump configured to pump fuel from the fuel reservoir to the heatsink.
